(19) United States
(12) Patent Application Publication
(10) Pub. No.: US 2006/0011685 A1
(43) Pub. Date: Jan. 19, 2006

(54) Compactable Table and Lap Cover

(75) Inventor: Derek Tai Tong, San Jose, CA (US)

Correspondence Address: DEREK TONG, 2091 WENDOVER LANE, SAN JOSE, CA, 95121, US

(73) Assignee: Mr. Derek Tai Tong, San Jose, CA (US)

(21) Appl. No.: 10/710,377

(22) Filed: Jul. 6, 2004

(51) Int. Cl. B60R 7/00

(52) U.S. Cl. 224/543

(57) ABSTRACT

The Compactable Table and Lap Cover with Cup holder is an attachable accessory to a vehicle or seat for purposes of providing a place for users to place items such as food and beverages. It also can act as a protection device for any food or drink spillage. The invention is designed to be a cost effective solution for vehicle manufactures enhance the utility functions of their vehicles without taking took much space within the vehicle. It is also designed to provide another utility option for standard chairs or seats anywhere.

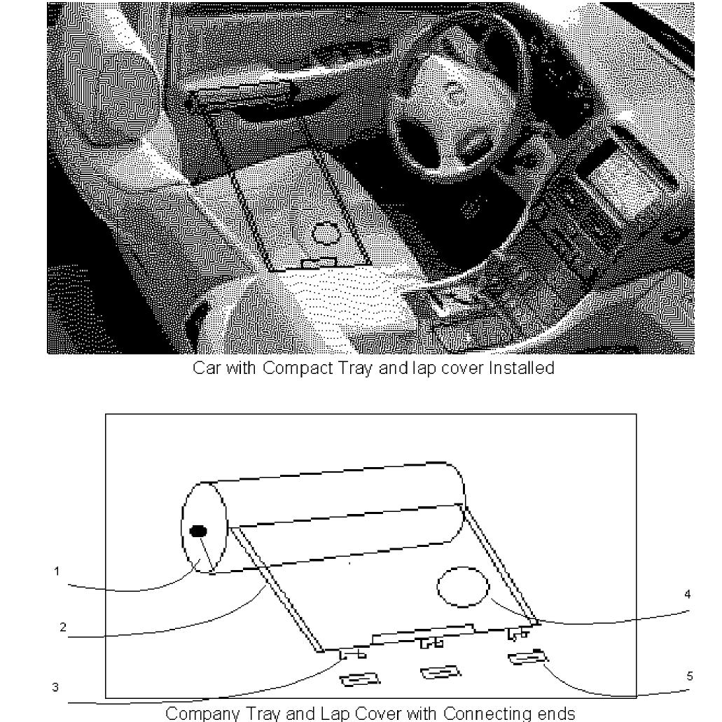

### DETAILED DESCRIPTION

The Compactable Table and Lap Cover with Cup holder is comprised of a cylinder shape similar to a roll of paper towel. Within the Cylinder it holds two pieces of flat material that is rolled up and fitted into the cylinder. One piece of material can be leather or thin metal or plastic alike. The purpose of the layer is to act as a table once it is unrolled and secured to the other end. The other piece of material with is layered and rolled on top of the first piece can be made of cloth or thin disposable material. The purpose of the second piece is to act as a protective layer to the first piece that can be removable for washing or disposing. The second piece can be attached to the first piece using Velcro or clips alike. The outer edge of the second layer should also be ridged for the purpose of preventing food or items from sliding off of the table while the vehicle is moving. Both pieces can have a hole of the same size and place designed as a cup holder. The cylinder can be designed with springs or motors to extend and retrieve the table for use or after use. The cylinder is also equipped with a lever to secure and pull the table once the table is attached to the other end to ensure that the table is tight enough for placing items on top of it. A handle can be attached to the end of both layers acting as place for users to pull and extend the table. At the end of both layers, hooks or attaching device alike are designed to tightly secure the table to the other end. The connectors for the table would be designed to attach to the glove compartment or area that is fitted to attach the table on a parallel manner.

It is desirable for drivers and passengers to have a place to put their food and drink while eating in the car. The Compactable table and Lap Cover with Cup holder once extended can allow for drivers and passengers alike to place items onto the table. Since the table is directly above their lap, it doesn't hinder their ability to use their hands and legs for driving and activities alike. The table can also provide protection for the lab of the user against spillage of food and drinks. Since the outer layer of the table is removable, it can be easily replaced or cleaned. The device can be made to fit into the car door or the space between the passenger and the driver. Once retracted, it is barely noticeable and therefore will not degrading the interior look of the vehicle or take up any space inside the vehicle. This device can also be apply to regular seats anywhere, such as planes, theaters or home coaches alike.

1. The device is a unique way to provide the person sitting in the seat to have a tray for food and beverages.

2. The device can also protect the person from drink and food spillage onto their pants or skirt while eating or drinking.

3. The device is specifically designed to be compact and non visible.

4. The device for the car is design to fit into the door of the vehicle or the central space between the passenger and the driver. For stand alone seats, the device is design to fit into either side of the seat, such as an arm rest.

4. The device can be designed with various sizes and colors to fit various vehicles and seats.

5. The cover piece of the device is designed to be removable for ease of cleaning.

6. The launching of the device can be mechanical or manual to match the design of the vehicle or the seat.

7. The device can have a hole(s) of various size on the service to act as a cup holding utility for the user.
